(19) United States
(12) Patent Application Publication
(10) Pub. No.: US 2007/0094256 A1
(43) Pub. Date: Apr. 26, 2007

(54) System and method for integrating and adopting a service-oriented architecture

(76) Inventors: Thomas D. Hite, Rockwall, TX (US); Shachindra Agarwal, Coppell, TX (US); Srikanth Subramanian, Allen, TX (US); Scott Wills, Lucas, TX (US); Cynthia Ann Wills, Lucas, TX (US)

Correspondence Address: ANDREWS KURTH LLP;Intellectual Property Department, Suite 1100, 1350 I Street, NW, Washington, DC, 20005, US

(21) Appl. No.: 11/515,013

(22) Filed: Sep. 5, 2006

Related U.S. Application Data
(60) Provisional application No. 60/713,381, filed on Sep. 2, 2005.

(51) Int. Cl. G06F 17/30

(52) U.S. Cl. 707/6

(57) ABSTRACT

A system and a method for integrating and adopting a service-oriented architecture that utilize such semantic searching. A exemplary system includes an application discovery and semantic analysis software tool. The application discovery and semantic analysis software tool includes a discovery engine that discovers application services, an application resource catalog that stores the discovered application services as software constructs in an application services ontology, and a semantic inference engine that semantically analyzes the software constructs in the application services ontology to determine relationships between the application services and enable more efficient searching of the discovered application services.

### RELATED APPLICATIONS

This application claims the priority of U.S. Provisional Application Serial No. 60/713,381, entitled “System and Method for Integrating and Adopting a Service-Oriented Architecture” and filed Sep. 2, 2005, which is hereby incorporated by reference in its entirety.

### BACKGROUND

Enterprise information technology (IT) departments, developers and others face a constantly growing challenge to keep track of enterprise applications and application services. Finding, understanding and relating applications and application services is difficult and time-consuming because of the lack of efficient and effective tools. Currently, IT departments must manually search for and locate application services and manually determine the relationships of the application services, e.g., by reading documentation and inferring relationships from the documentation. Such manual processes are is inherently labor and time intensive. Text-based search tools are of limited value because they cannot extend a search to, or across, aggregated metadata that relates application services to one another, whether by subsumption, identical or transform relationships (direct reference), much less any relationship statement that can be represented by first order predicate logic. Text-based search tools provide a list of containing entities, usually files or documents, in which a matching regular expression exists, but there are more significant problems facing developers. In particular, terms in metadata or source code that are useful to developers rarely match English, much less any other spoken language and, therefore, are not generally locatable using text-based search tools.

### SUMMARY

An advantage of the embodiments described herein is that they overcome the disadvantages of the prior art. These advantages and others are achieved by a system for integrating and adopting a service-oriented architecture that utilize such semantic searching. A exemplary system includes an application discovery and semantic analysis software tool. The application discovery and semantic analysis software tool includes a discovery engine that discovers application services, an application resource catalog that stores the discovered application services as software constructs in an application services ontology, and a semantic inference engine that semantically analyzes the software constructs in the application services ontology to determine relationships between the application services and enable more efficient searching of the discovered application services.

These advantages and others are also achieved by a computerized method for integrating and adopting a service-oriented architecture that utilizes such semantic searching. The method includes gathering application content, identifying application services from gathered application content and populating an application resources catalog with application services identified from application content. The application resources catalog is populated with an ontology created from identified application services and information from gathered application content. The method further includes semantically identifying dependencies and semantic relationships between application services from ontology. A computer-readable medium that includes instructions for performing this method also achieves these and other advantages.

These advantages and others are also achieved by a computerized method for discovering application services. The method includes generating an application services ontology that includes application resources, building references between application resources, the references indicating related application resources, dynamically generating ontology documents that include application resources and related content and semantically scanning and analyzing the ontology documents. The semantically scanning and analyzing ontology documents identifies semantic relationships between application resources. A computer-readable medium that includes instructions for performing this method also achieves these and other advantages.

These advantages and others are also achieved by a computerized method for discovering application services. The method includes reading application content that includes application services and other application data, discovering application documentation in the application content, indexing application data from the application content, and resolving application relations that indicate relationships between application services. The application relations are resolved using one or more semantic algorithms. A computer-readable medium that includes instructions for performing this method also achieves these and other advantages.

### DESCRIPTION OF THE DRAWINGS

The detailed description will refer to the following drawings, wherein like numerals refer to like elements, and wherein:

FIG. 1A is a block diagram of an embodiment of system for integrating and adopting a service-oriented architecture.

FIG. 1B is a flowchart of an embodiment of method for integrating and adopting a service-oriented architecture.

FIG. 2 is a flowchart of an embodiment of method for discovering applications.

FIG. 3 is a flowchart of an embodiment of method for discovering applications.

FIGS. 4A and 4B are screen shots of user interface screens showing semantic search and results.

FIG. 5 is a block diagram of exemplary hardware components for implementing embodiments of system for integrating and adopting a service-oriented architecture.

### DETAILED DESCRIPTION

Described herein are a system and method for integrating and adopting a service-oriented architecture. An embodiment includes the IQ Server, which provides a software solution for Enterprise Application Visibility—a unified, enterprise-wide view of application capabilities. Embodiments described herein help companies find, understand, and re-use existing application services for integration and adoption of a service-oriented architecture (SOA). Application services are functions provided by an application and a SOA is an architecture of application services available in an enterprise.

In order to provide Enterprise Application Visibility, application service relationships are determined. Accordingly, embodiments described herein generally answer questions asking whether applications services are related to one another and what application services are related to a given concept or term. For example, IQ Server may answer questions, in general, in the form of:
“Is Service1 in Application1 related to Service2 in Application2 ”?
“What services in my applications are related to the concept of ‘Customer Order’”?

The IQ Server may answer such questions by discovering, organizing, and relating enterprise application functions (i.e., application services) and their parameters, referred to as application resources and found in application metadata and source code files. The discovery operation of embodiments described herein is performed using a mixture of deterministic and heuristic algorithms that read structured content (i.e., application metadata, source code) and unstructured content (i.e., text documentation, system configuration information, etc.) in such a way that a computer can understand and relate the contained information.

Deterministic algorithms are algorithms that resolve to distinct, knowable values. Accordingly, deterministic algorithms are used to identify discrete and uniquely identifiable entities in applications and data systems, known as software artifacts. Software artifacts are synonymous with application resources. Deterministic algorithms known to those of ordinary skill in the art may be used. In the embodiments described herein, deterministic algorithms generate, from the software artifacts, an application ontology that uniquely identifies what are ‘usable things’ in applications (i.e., what are application services), and what ‘things refer to other things’ in the applications (i.e., what application services refer to other application services), where a ‘thing’ is an ontology member.

Not all relationships can be found using deterministic algorithms. For example, cross-application relationships are not easily, or worse not possibly, identified by a service call from one application into another through a remote function call protocol, such as a Web Service or Remote Procedure Call (RPC). Embodiments described herein use, among other things, a set of heuristic algorithms that treat the application metadata and documentation as content for use in latent semantic analysis (see below). Heuristic algorithms known to those of ordinary skill in the art may be used.

One interesting thing about the ontology created by the deterministic algorithms, and central to the embodiments described herein, is that the ontology members can be ‘anchor points’ to which documentation content can be “dynamically attached”. Consequently, a properly formed application ontology member can be considered to be the title of an “ontology document” (OD). An OD is a fictitious document generated dynamically by relating content (such as textual descriptions) with ontology members. Ontology members of ontologies created by embodiments described herein are software artifacts (i.e., application resources).

When answering questions, such as the two bulleted questions above, a developer would commonly read documentation and hope to ‘infer’ the relationships from the documentation itself. Document Inversion Semantics (DIS), a technique used by embodiments described herein, including the IQ Server, automates this manual process by comparing ODs using various mathematical techniques. The outcome of the comparison is a confidence that the two ontology members are related (e.g., a percentage indicating the degree of confidence that the two ontology members are related). If two ontology members (i.e., two application resources) are related then that means, by definition, the services (or parameters, etc.) represented by the ontology members are also related.

The operation of comparing two ODs in this way is referred to as a “semantic search”. The semantic search is utilized by embodiments described herein and is a basis of the IQ Server's operations. In order to perform semantic searches, an implementation of the IQ Server is broken into three distinct components: Discovery, Application Resource Catalog (ARC) and IQ Search.

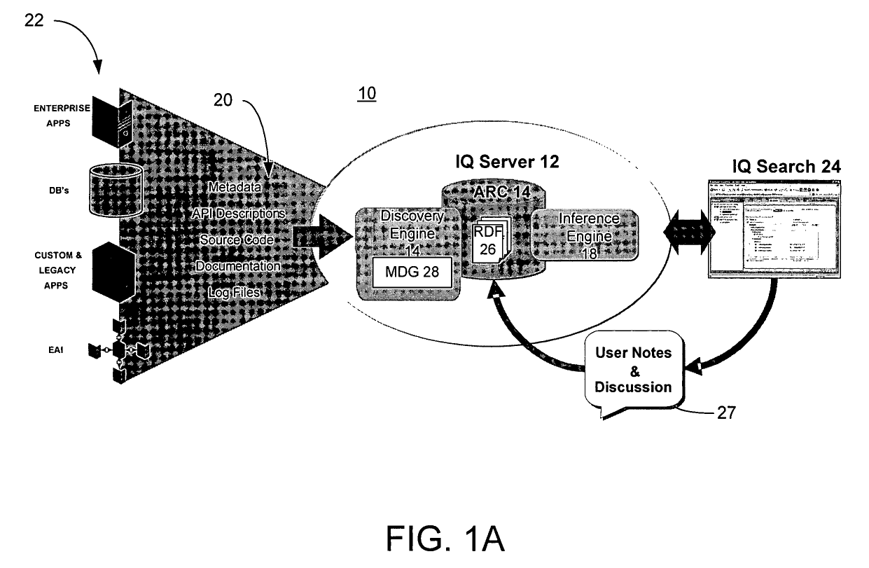

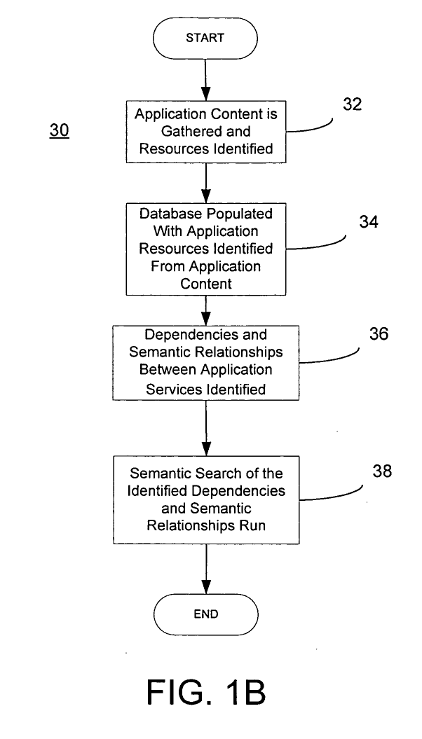

With reference now to FIG. 1A, shown is an embodiment of system 10 for integrating and adopting a service-oriented architecture that utilizes such semantic searching. System 10 includes an application discovery and semantic analysis software tool, IQ Server 12. IQ Server 12 may be software application hosted on a server or other computing device with a network connection. As shown, IQ Server 12 includes discovery engine (DE) 14, application resource catalog (ARC) 16 and semantic inference engine (SIE) 18. DE 14 gathers or receives structured and unstructured application content 20 (including metadata, application programming interface (API) descriptions, source code, documentation and log files) and identifies application resources from the application content 20. Application content 20 may be gathered from application sources 22 such as enterprise applications, databases (DBs), custom and legacy applications and enterprise application integration (EAI). Structured content gathered by DE 14 may be stored as a Resource Description Framework (RDF) graph 26 in ARC 16. System 10 may also include IQ Search 24. IQ Search 24 may be a software application hosted on a server or other computing device with a network connection (may be same or different computing device hosting IQ Server 12). IQ Search 24 allows a user to search results created by IQ Server 12 to find, understand and re-use application services identified and related in ARC 16. User Notes & Discussion 27 is a feedback mechanism for end users to introduce additional ‘descriptive’ content and/or metadata. IQ Search 24 interface allows users to introduce such descriptive content (e.g., ‘user notes’ and ‘discussion’ information) by typing such information into an IQ Search 24 interface. These notes are then indexed into ARC 16 as if read by an MDG 28 during the discovery process.

With reference to FIG. 1B, shown is exemplary embodiment of method 30 for integrating and adopting a service-oriented architecture, performed using system 10. In a “Discovery” step, metadata and other application content 20 is gathered, block 32, and a database populated with application resources identified from application content 20, block 34. DE 14 may perform these actions, populating ARC 16 with ontology of application resources identified from application content 20 (ARC 16 may be standards-based in that data is stored in ARC 16 in a standards-based format). DE 14 preferably uses deterministic algorithm(s) to identify application resources from application content 20. In a “Semantics” step, dependencies and semantic relationships between application services may be identified, block 36. SIE 18 may perform these actions utilizing ontology stored in ARC 16. SIE 18 preferably uses semantic algorithm(s) to identify dependencies and semantic relationships between application services. Semantics, as discussed herein, are key to finding and re-using services. The DIS discussed herein is automated by system 10, particularly by DE 14, ARC 16 and SIE 18 in performing Discovery and Semantics. Indeed, Discovery and Semantics are integrated aspects of overall Discovery process (see below). In a “Search” step, a semantic search of the dependencies and semantic relationships identified in Semantics step may be run, block 38. IQ Search 24 may be used to perform Search step. Search outputs results identifying application services located by search, indicating semantic relationships. By semantically locating application services, search helps users quickly find, understand and re-use application services they would not have found or understood using standard text-based search. In essence, Search, and IQ Search 24, work like a Google™ for application services (software artifacts) identified and semantically related using system 10.

IQ Server 12 may be referred to as a ‘search based solution’ for IT. This does not mean, for instance, that the extent of system 10 is simply that users issue search queries and expect source or metadata files as a result of the search. On the contrary, the basis of search refers to the fact that IQ Server 12 uses a proprietary blend of well-founded research from semantics and information retrieval and proprietary techniques to identify relationships between software artifacts.

With continued reference to FIGS. 1A-1B, a primary job of embodiments of IQ Server 12 described herein is to find software artifacts that semantically match specified queries. The general nature of this is to blend reasoning on graphs representing the known structural relationships between software artifacts created by scanning appropriate metadata, source code, etc., and comparisons between ODs generated by scanning the same content, as well as other unstructured content.

It is not enough to just compare documents that one normally associates with software. Such documents are source files, metadata files, database schema, XML documents, etc. These types of documents, if compared by any normal semantic model, would not return particularly ‘closely related’ documents due to the nature of the terms used in each of the documents. The terms in such documents are often cryptic programming terms, such as XQR22 (which may translate in ‘English’ to be “the name of the database table representing ‘Invoice’”).

With continued reference to FIGS. 1A-1B, consequently, it can be summed up that embodiments of IQ Server 12 do the following:
Scan structured application content to create ontologies that represent software artifacts (i.e., application resources) and create a graph (e.g., a RDF graph) of the structured content.
Ascribe meaning to the ontology members (i.e., software artifacts) by attaching appropriate documentation (e.g., documentation found in application content) to the ontology members, therefore creating the dynamic ODs.
Semantically reason about the relationships between the ontology members in the graph, identifying and relationships and elucidating and understanding of the relationships.
Compute similarity between the dynamic ODs that ascribe meaning to ontology members via well-founded and proprietary Latent Semantic Analysis (LSA) techniques (LSA techniques are known and understood by those of ordinary skill in the art).
Augment the RDF graph above by computing similarity between software artifacts using the ODs.

The dynamic creation of ODs that ascribe meaning to software artifacts (ontology members), and the follow-on LSA, which is by definition performed on those software artifacts, is what we refer to as DIS. IQ Server 12 itself is a document inversion-based semantic engine. In IQ Server 12, it is the software artifacts themselves that become documents, as opposed to documents being containers of software artifacts.

The document inversion is performed by the automated discovery process. With reference to FIG. 1A, discovery may be achieved by discovery metadata generators (MDG) 28 that read both structured application source files, metadata, etc. and other forms of unstructured application content such as documentation, source comments, etc. in order to build ARC 16.

The Discovery Process

The discovery process is the process by which embodiments described herein, including IQ Server 16, obtain and store information about application service components, including those from packaged applications, integration brokers, application servers, Web Services, legacy systems, etc. The information obtained from the discovery process, although typically found in various vendor-specific formats, often contains the same elements needed by IQ Server 12 to automate the creation of ARC 16. IQ Server 12 uses MDGs 28 to convert information describing the application service information into an ARC 16 format. DE 14 may include MDGs 28, MDGs 28 may be separate software components of IQ Server 12 or MDGs 28 may be remotely located from IQ Server 12 (see below). In embodiments, DE 14 orchestrates the execution of MDGs 28 while MDGs 28 perform the actual discovery operations. In such embodiments, DE 14 is the manager for kicking off (executing) MDG clients 28 in an ordered fashion. The ARC 16 format may standards-based. Examples of ARC format that may be used, include formats based on Web Ontology (OWL) documents (documents stored in a format consistent with the World Wide Web Consortium's OWL schema) and Resource Description Framework (RDF) documents (documents stored in a format consistent with the World Wide Web Consortium's RDF schema).

IQ Server 12 may expose discovery functionality through an API known as External Interface (ExtIF), which supports a plug-in architecture that accepts commands from any MDG that reads and interprets information about application services. Through ExtIF, third party developers can generate a MDG that makes function calls to ExtIF, which converts and stores the information into ARC 16 format.

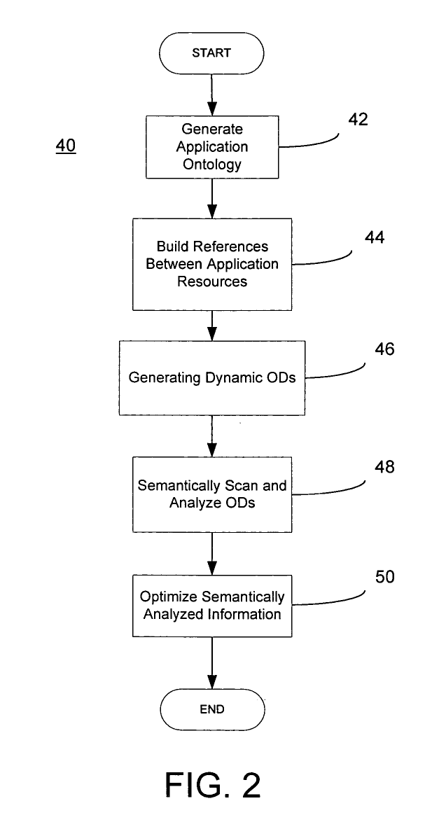

With reference now to FIG. 2, shown is an embodiment of the discovery process, method 40 of discovering applications. Method 40 automates the building of ARC 16. Method 40 of discovering applications is an aspect of method for integrating and adopting a service-oriented architecture. Method 40 comprises performing Base Discovery—generating application ontologies (e.g., storing application resource “anchors” as ontology members), block 42, performing Reference and Relate—building references between application resources, block 44, and generating dynamic ODs, block 46, performing Latent Semantic Analysis—semantically scanning and analyzing information generated in previous steps (e.g., ODs), block 48 and optimizing semantically analyzed information, block 50.

Base Discovery builds the base of ARC 16 and comprises generating the application ontologies—building the ontology anchors 42 (identifying and storing software constructs) for establishing relationships, references and documentation content. The software constructs may be identified using deterministic algorithm(s). Once the ontology anchors are in place, the relationships can be identified and established with documentation content attached to the anchors.

Reference and Relate comprises generating deterministic relationships and reference information 44. This may be done using known deterministic algorithms. For example a foreign key is a deterministic reference between two tables, and also a deterministic identical relationship between the columns connected by the foreign key. Reference and Relate may also comprise generating dynamic ODs 46, e.g., associating documentation (generally descriptive text) with each ontology member in ARC 16. The documentation is preferably attached to the ontology member in ARC 16. Each set of descriptive text attached to an ontology member is considered to be a ‘document section’ and the set of sections is the ‘document’. The document title is the ontology member itself. In this way, IQ Server 12 can be viewed similarly to an Internet search engine—it indexes documents and compares those documents. By doing so IQ Server 12 is, in essence, comparing the meaning of application resources. Since the document can have one or more sections, each section may be obtained by various means, and from various information sources, by MDGs 28. In addition, MDGs 28 may decide that a particular section is ‘more important’ relative to another by applying a weighting factor to each section. IQ Server 12 uses the weighting to give more emphasis in its mathematical calculations to certain sections of document content than others. IQ Server 12 also considers certain portions of the software artifact's resource structure itself as document sections.

Performing LSA comprises semantically scanning and analyzing information 48 generated and stored in ARC 16 by prior steps. Once the base deterministic information and appropriate documentation is gathered and stored in ARC 16, IQ Server 12 scans and analyzes various portions of ARC 16 using, e.g., a blend of well known and/or proprietary latent semantic analysis techniques (semantic algorithms). This analysis applies certain content weighting and information indexing. The scanning operation is done by applying the semantic algorithms to the ODs stored in ARC 16. Each section of the OD is analyzed and certain weightings may be applied, possibly by heuristically determining the quality of the content in the sections. A greater weight means that content more powerfully states the meaning. The results of this process is that ARC 16 then contains a highly optimized index for comparing ODs against each other, later, to determine how similar they may be. More similarity would lead IQ Server 12 to believe the ODs (and thus, the underlying software artifacts) are reasonably related. Optimizing semantically analyzed information 50 comprises IQ Server 12 optimizing the semantically analyzed information in ARC 16 in preparation for high speed search and relationship inferencing.

With continued reference to FIG. 2, a very important feature of the embodiments described herein, including IQ Server 12, is automated creation of ARC 16. In an embodiment, IQ Server 12 generates the application ontology 42 by attaching to, and/or scanning source code, metadata, schema, unstructured content (for example documentation) and other information comprised by various applications (i.e., application content). The discovery process builds metadata about the software constructs of these applications and annotates them as ODs, as appropriate. Although a single installation of IQ Server 12 may discover multiple applications and ancillary documentation, in an embodiment each application is discovered and represented independently within ARC 16 ontology and resource sub-sections, for example, as described in pending U.S. Patent Applications entitled “System and Method for Relating Applications in a Computing System,” Ser. No. 10/933,216, “System and Method for Relating Computing Systems,” Ser. No. 10/933,212, and “System and Method for Describing a Relation Ontology,” Ser. No. 10/933,211, all filed on Sep. 3, 2004 and hereby incorporated by reference.

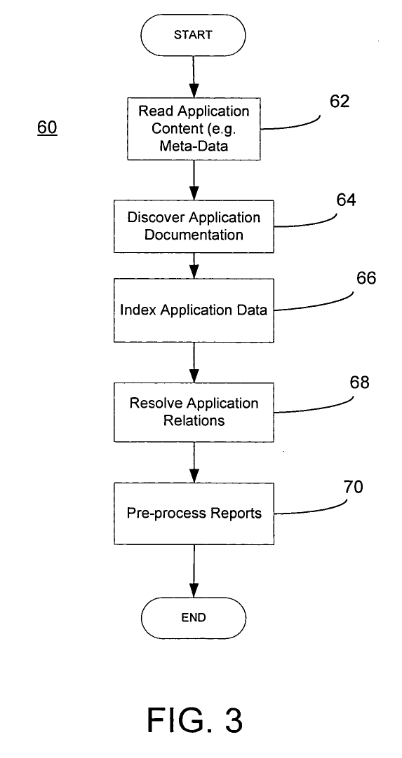

With reference now to FIG. 3, another embodiment of application discovery is illustrated. Shown is method 60 of discovering applications which includes reading application meta-data, block 62, discovering application documentation, block 64, indexing application data, block 66, resolving application relations, block 68, and pre-processing of reports, block 70. Reading application meta-data 62, discovering application documentation 64, and indexing application data 66 are an embodiment of performing the base discovery 42 and reference and relate 44 described with reference to FIG. 2, while resolving application relations 68 and pre-processing of reports 70 are embodiments of performing LSA 46 and optimizing 48.

Reading Application Meta-Data 62

To discover application and information systems, embodiments, including IQ Server 12 employs metadata generators (MDGs 28). MDGs 28 are plug-in modules—e.g., one for each application platform. For example, there may be MDGs 28 for Java, Visual Basic, C#, ASP, JSP, COBOL, RPG, Oracle, Sybase, SQL Server, WSDL, Tivoli, Monk, etc. There may also be separate MDGs 28 for more service oriented applications, e.g., SAP, Siebel, Oracle Financials, Peoplesoft, WSDL repositories, etc. Reading application meta-data 62 comprises MDGs 28 scanning the application content to discover application constructs.

Reading application meta-data 62 further comprises storing the discovered application constructs into ARC 16 including, but not limited to, resources, relationships, references and related unstructured content (e.g., documentation). It is important to note that application constructs in their native environment may be different from other applications, but are stored in the ARC 16 as metadata in a canonical form, translating the application constructs into a common descriptive syntax. MDGs 28 are responsible for this translation. MDGs are client applications that may or may not be local to IQ Server 12 and attach to IQ Server 12 using an externally exposed interface (e.g., ExtIF).

During this phase the application resources, their attributes, and attached documentation are discovered. MDGs 28 also discover the concrete (deterministic) relationships as well as hints about non-deterministic relations among the application resources. All this information is added to ARC 16.

Discovering Application Documentation 64

After the resources are discovered, discovering application documentation 64 may comprise reading application documentation by documentation meta-data generators. Documentation meta-data generators may be MDGs 28, just optimized for reading text (unstructured) content instead of structured content like source code. The application documentation may be in the form of MS Word, PDF, HTML, XML, etc. files and may include User's Guide, Programmer's Guide, etc. The documentation meta-data generators use different format plug-ins and a set of rules to identify the resources in these documents and attach the associated description as the resource documentation in ARC 16. Some of the rules are generic whereas others may be written specifically for application content a MDG is reading at any given time.

Indexing Application Data 66

Indexing application data 66 may involve indexing the application data (application constructs) thus discovered for optimized access. This may involve indexing the plain text resource description data using some standard algorithms like Latent Semantic Analysis as well as some custom algorithms and heuristics.

Resolving Application Relations 68

The first three of steps in discovery process produce concrete relationships, and hints about relationships that are not deterministically resolvable (i.e., are ambiguous), between the application resources. In addition, appropriate textual documentation has been attached to the resources, and indexed, as determined by the discovery algorithms.

Resolving application relations 68 then resolves ambiguous relationships as much as possible. In short, embodiments described herein, including IQ Server 12, resolve these using semantic search that compares DIS documents.

A very simple example can be shown in the context of the example Java code below:

class Customer
{

// send email to the customer
public void sendEmail(int emailType)
{

...
...

}

}
class Sale
{

// This method processes a purchase by a customer
public void purchase(Customer cust, Item item)
{

// charge the customer
...
...
// send the customer a confirmation email
cust.sendEmail(CONFIRMATION);

}

}

One goal in this example might be to resolve the relationship between customer e-mails and the method “purchase( )”. The method “purchase” belongs to an object instantiated as ‘cust’, but the nature of that object is not known via the code snippet. However, the ambiguous relationship between the “purchases( )” method and the call it makes to cust.sendEmail( ) is a viable hint, as well as the comments in the code snippet itself. Resolving application relations 68 comprises the algorithms analyzing all ambiguous reference information, including but not limited to, the documentation (comment content in this case) discovered as well as the declaration of cust object itself. Through this type of semantic search, IQ Server 12 may be able to identify the exact method that ‘relates’ to cust.sendEmail( ) in that particular call context. Resolving application relations 68 then includes adding resolved relations to ARC 16 as concrete relationships.

Report Pre-Processing 70

Embodiments described herein, including IQ Server 12, may present many reports to the user. Report pre-processing 70 may include pre-processing some of the reports for optimized access later on. Report pre-processing 70 may include querying ARC 16 for the raw data necessary for the reports and computing information to be displayed for all such reports.

Discovery Orchestration

The application discovery described herein is a multi-step process. Moreover, a client may need multiple applications to be discovered with custom configurations. IQ Server 12 may orchestrate the entire process and allow the user to start the automated discovery process manually or periodically by schedule.

Incremental Discovery

The discovery process may be time consuming for large installations. To address this issue, embodiments, including IQ Server 12, may provide incremental discovery that is much faster than full discovery, and can be run periodically. The incremental discovery identifies updated content in applications and amends ARC 16 with only the updated information. As ARC 16 also contains the resource relations (concrete, ambiguous and inferred), the incremental discovery corrects this information to ensure data consistency. When incremental mode is activated, all the discovery steps are preferably run in the automated ‘incremental’ mode.

### Implementing DIS for End-user Search and View on Resources (Software Artifacts)

Software architects and developers are constantly searching through files using time tested tools such as (Unix based) grep and find. While these tools provide certain insight into files in which a particular word, or matching ‘regular expression’ can be found, they do not provide any particular insight into the details of what was found. Moreover, a text scan cannot provide inter-dependency or similarity information regarding software artifacts.

For instance, just finding a keyword or matching a regular expression does not equate to locating a variable that may hold a value that is represented by the search phrase. A variable, Q, in an application may hold an instance of a CustomerRecord, but there is no indication that Q itself matches CustomerRecord, much less a very loose regular expression like '.*[cC].*[rR].*. The match must instead be found via semantic relationships.

This type of resource search is a major application of embodiments described herein, using semantic inference and search. With reference again to FIG. 1A, a user may enter, into a IQ Search 24 user interface, a search phrase, such as “Customer Record Variable” and SIE 18 retrieves the resources (such as Q in the above example) that semantically relate to search phrase and ranks those resources in order of relevance.

SIE 18 also may determine that the search phrase exactly describes a resource name and searches for matching resource names as well. These matching resources are considered as ‘direct hits’. This is somewhat similar to a ‘grep’ search and is the lowest common form of search hits.

More importantly, the ‘document’ that is returned by a search result (the ‘resultant link’ as in Internet search sites), is a dynamically generated aggregation of the resources and metadata that are directly or indirectly related to (referenced by or referencing) the resultant resources (search hits). To create the ‘dynamic ontology documents,’ SIE 18 extracts all explicit, implicit and ambiguous relations to and from the resource and consolidates the resources linked by those relationships as dependencies.

The linked dependency resources may be from the same atomic application, a database used by the application, or a completely different atomic application. SIE 18 may also have to ‘hop’ across multiple applications to identify these linked resources. In a loose sense, this is somewhat similar to link conjecture in a standard search engine, however, it is much more accurate given the nature of the metadata IQ Server 12 creates.

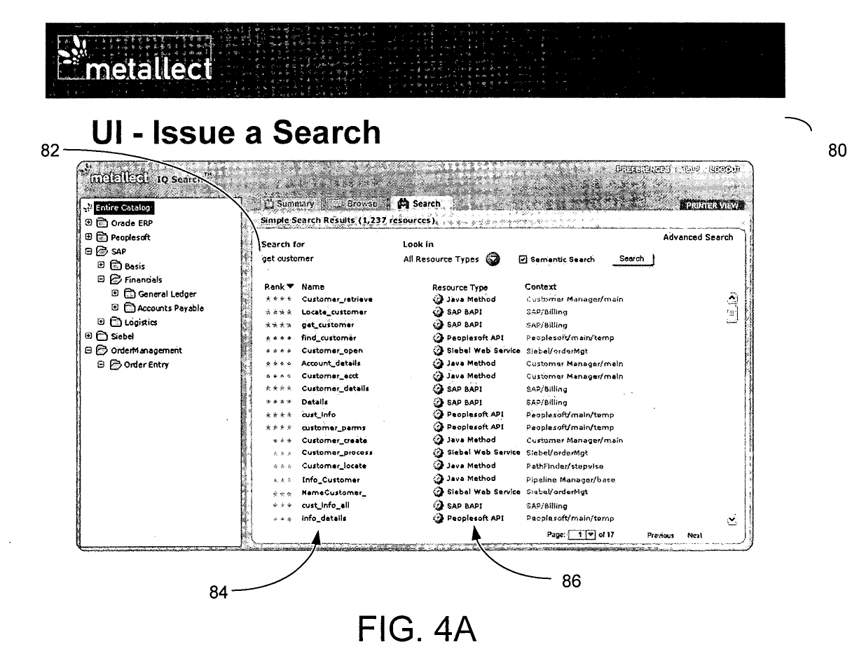

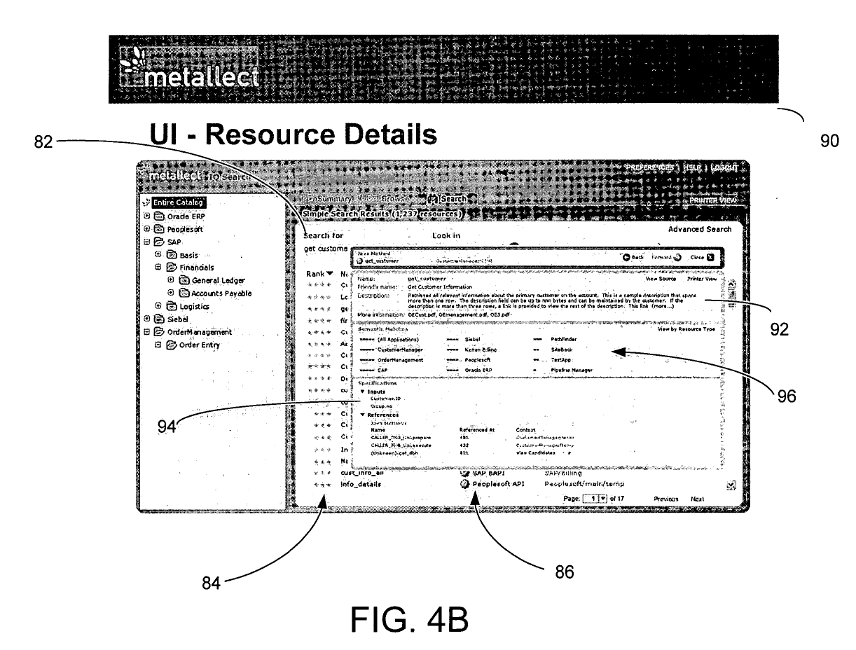

With reference now to FIGS. 4A-4B, shown are screen-shots of IQ Search 24 user interfaces illustrating an exemplary end-user search and results. FIG. 4A shows a search and result user interface 80. A user has entered “get customer” as search term 82. SIE 18 conducted a semantic search using “get customer” and returned search results 84. Search results 84 include the names of each software construct that was determined to semantically match the phrase “get customer”. The search was run on all resource types, and the resource type 86 of each software construct is provided.

FIG. 4B illustrates a resource detail interface 90. Resource detail interface 90 provides details about a software construct selected by user from search results 84. Resource detail interface 90 displays information retrieved during discovery process and stored in ARC 16, including application construct description 92 and parameters 94. Resource detail interface 90 also includes semantic matching information 96, showing how well application construct (“get_customer”) semantically matches other applications.

In certain instances, the relationship between an application resource and the application resource's dependencies cannot be uniquely determined. In such a case, SIE 18 produces associations to the candidates of the irresolvable relationship, which are called ambiguous relationships. The user may need to view such ambiguously linked resources in order to understand potential dependencies, for instance in the event (s)he intends to modify the resource in any way. SIE 18 may issue an internally generated semantic search, which locates all the resources that plausibly satisfy the linked ambiguous resource criteria. In the same way as above, the return from the search is ranked by relevance and the same aggregated metadata ‘dynamic document’ is generated for each return result.

Why Strictly Text Search Fails

Text based search tools cannot extend a search to, or across, aggregated metadata that relates resources to one another, whether by subsumption, identical or transform relationships (direct reference), much less any relationship statement that can be represented by first order predicate logic. The relationship may be a reference to a different resource, or yet another resource referencing the resource found through the initial search. In short, standard search tools do not ground to a software artifact, rather, they ground only to containing entities, such as files.

Too often, creating even the most sophisticated regular expression ends up a lesson in futility for developers because the answer they desire is actually a term that does not match the regular expression. The expected result is a variable name not at all resembling (in textual or physical context) the regular expression. For instance, consider that searching for ‘Customer Record’ will likely not return any results in which a column name ‘F0’ exists, which may well be the column that holds Customer Record information.

Text search tools provide a list of containing entities, usually files or documents, in which a matching regular expression exists, but there are more significant problems facing developers. In particular, terms in metadata or source code rarely match English, much less any other spoken language. A much more relevant search result to IT staff is the software artifact that is conceptually representative of the query (function, variable, database column, etc.) and includes the relationship between the resultant resource and other resources it uses (references) and those it is used by (referenced by).

In short, a useful search result for application developers looking into dependencies must be the aggregated view of the ‘answer resource’ and any information about what relates to that answer. Understanding the related information is crucial, for instance, in understanding impact of changing a resource.

Why Semantic Search Succeeds

Semantic search, e.g., as implemented by embodiments described herein, by comparison, enables developers to quickly find existing software artifacts and their inter-dependencies by automatically relating the structure, documentation, lexical information, and any available cross-reference information using a concept query search on application content. Application content is any form of information that describes the structure, capabilities, execution state information and description of software (artifacts). An enormous amount of application content already exists in the form of:
Metadata
API descriptions
Source code
Schemas
Log files
Messages and Integration Broker Transforms
Documentation

This application content is difficult to gather, organize and relate together because unlike web pages and other documents searched using grep, or indexed by Internet search engines, application content is dispersed among multiple files and documents. Additionally, application content is not as standardized or descriptive as natural language documents.

Application content comes in a wide variety of formats and physical term nomenclatures (source code, API definitions, schemas, etc.) that are specific to each individual application. Many applications are poorly documented or use cryptic naming schemes. For example, a service to check inventory levels might actually be named X5_IN.

Even if one were able to gather all of the application content for an application, it would take an exorbitant amount of time and effort to inter-relate and make sense of it all. For example, a text search for “Check Inventory” certainly wouldn't return X5_IN. One has to go beyond keywords searches towards searches based on meaning, or semantics.

The problem, simply stated, is that terms used in applications are particularly useless, such as ‘var1’, ‘ColumnF0’, etc. Hence, grep and find can only be successful if one already knows the answer (‘var1’ and ColumnF0) so that a regular expression can be formed to match these.

Embodiments described herein relate terms to other terms, which is somewhat of an inversion from normal content and semantic engines. The embodiments use query phrases as conceptual as well as regular expressions. For instance, consider the following:
DB.WRS01.F0 ‘relatesTo’ PerlModule.Variable.$Q1
Each holds the value of ‘Customer Credit Card Number’ because $Q1 is set equal to a return from a ‘SQL SELECT’ on DB.WRS01.F0 somewhere in the source code
DB.WFS01.F0 is seen, (for example via lexical cohesion in documentation), to be described by ‘Customer Credit Card’

Given these a semantic search for ‘Customer Credit Card’ results in both DB.WRS01.F0 and PerlModule.Variable.$Q1.

Semantics: The Key to Application Software Artifact Search

Semantic search is the ability to search based on meaning rather than keywords. For example, if a developer wishes to find all of the application services across an entire company that have something to do with (relate to) ‘changing a customer address’, it would be futile to find only the application services that contained the actual keywords “changing a customer”, or any reasonably structured regular expression because many meaningfully related results would be missed.

Without end-user available semantic search technology, application services must be located and deciphered manually. In other words, when an IT worker receives a business request, they must talk to subject matter experts and sift through documentation (if it exists) to determine which application services can be reused. Some organizations even have “librarians” whose sole job is to help developers and architects find the right application services. This process is inefficient at best.

Semantic inference-based search solves these problems. However, there's an additional issue that must be resolved: most existing applications are not encoded with semantic intelligence. For example, application metadata does not generally attempt to resolve that a service named X5_IN has something to do with the concept of inventory.

There are two ways to add semantic intelligence to existing applications:
Manually find, analyze, and document the hundreds of thousands of application services that already exist in the organization. This is not a practical option, as it would take many years of effort.
Automatically determine semantics using an algorithmic approach. This is a significant technical challenge, but it is the only practical option and the one offered by embodiments described herein.

### Automating Semantics: Introduction to the IQ Server Semantic Inference Engine

Semantics are the key to finding and reusing existing application services. In order to infer semantics automatically, sources of application content must be analyzed by the semantic inference engine using a variety of semantic distancing techniques.

To illustrate the role of SIE 18 in determining semantics, consider a scenario in which a developer is analyzing a single custom-developed Java application and an underlying SQL database. These applications expose relatively specific sources of content:
Java source code
Comments and developer notes (in the code)
A database schema

By properly discovering these content sources, latent semantic analysis can be performed, after which SIE 18 can infer semantic relationships between the application resources.

For example a method in the Java application named pr_inv_lv( ) contains a SQL statement that operates on a database table named “product_inventory”. From this relationship, SIE 18 will (via a proprietary spreading activation technique) automatically associate the term “inventory” with the pr_inv_lv( ) service from the database table. Because this relationship was identified by SIE 18, a semantic search for the word “inventory” would return the pr_inv_lv( ) service, whereas a text search would not.

This is a very simple example of one of the techniques used by SIE 18 to determine semantic relationships. SIE 18 utilizes other latent techniques based on high order mathematics and heuristic algorithms.

It is important to note that semantic inference is not an exact science. For every application service that is analyzed, SIE 18 attempts to “build, or augment, a case” that two resources are similar, or related. A case, in this context, is synonymous with the localized RDF graph generated regarding resources. As such, a case is built upon multiple pieces of evidence that come from analysis of each source of content and each individual inference technique. In other words, the inference engine reasons on the semantic cases built during discovery.

Because SIE 18 will identify a large number of semantic relationships (tens of millions in a large application environment), ranking is critical. A semantically inferred relationship with a 95% confidence ranking is much more likely to be useful than one with a 42% confidence ranking. SIE 18 ranks inferred relationships based on the case it was able to build for that relationship. A relationship that is supported by multiple pieces of evidence will receive a higher ranking than a relationship that is supported by only one piece of evidence. It is with the confidence ranking that SIE 18 increases the signal-to-noise ratio, making the results much more useful.

When SIE 18 completes its work, the result is “clusters” of conceptually related application services. For example, there may be a cluster of application services around the concept of an “order”. Clusters are multi-dimensional and they overlap with other clusters, effectively forming a bottom-up ontology based on the “as is” application environment. This is counter to the way ontologies are traditionally built using a manual, top-down approach that may take months or years.

The final result of semantic inference is a highly enriched dataset that contains a comprehensive list of application services and their relationships to other services and various business concepts.

Pulling it all together

Once applications have been discovered and semantically enriched through DIS, the semantic search engine (IQ Search) can index this information for optimized search speed. From an end-user perspective, semantic search appears similarly to Internet search engines, but rather than searching for keywords semantic search makes use of proprietary spreading activation to traverse the ontology, and the subsumed ontological attributes, built by the inference engine.

The following diagram illustrates the difference between text search and semantic search:

[image]

For example, a search for “change address” using embodiments described herein will return all application services that are semantically related to the concept of changing an address. Many of the search results will not contain the words “change” or “address”, and without automated semantic inference there is no way to find and reuse these cryptically named application services. Note that the results show the confidence level (percentage) that the found application services match “change address”.

### Implementing DIS for Application Portfolio Management

The following provides additional detail and description of the “Semantics” step discussed above and the LSA described above. Application Portfolio Management (APM) is a term applied to the operations required to maintain and upgrade existing application infrastructures. As such, an APM solution must provide IT developers the ability to find, understand and reuse software artifacts, and their interdependencies, in the most expeditious way.

Upwards of two thirds of the time and cost associated with any maintenance effort is spent determining how to fulfill the request as opposed to actually implementing the request. The how process includes answering two fundamental questions:
Where within the software do I make the required changes?
What will be the (intra- and inter-application dependency) impact of making these changes?

A complete semantic search solution for APM requires the same fundamental components as a semantic search solution:
A Discovery Engine (e.g., DE 14) to gather and normalize various forms of application content
A Metadata Registry (e.g., ARC 16) to store descriptions of application services and associated application content
A Semantic Inference Engine (e.g., SIE 18) to identify semantic relationship dependencies between all discovered application artifacts
A user oriented Search Engine (e.g., IQ Search 24) to index semantically rich metadata for high speed search and relationship/dependency view aggregation.

As a search-based solution for APM, IQ Server 12 automatically discovers applications and related information systems in an enterprise. Once discovery is complete, IQ Server 12 may provide many intelligent reports about these applications to the IT project teams and IT executives. Examples of reports provided are described below. The details of ARC data generation to support those features is discussed in more detail below.

Relationship Inference

IQ Server 12 utilizes SIE 18, internally, to infer many relationships based on the discovered application data. In some cases, the discovery process is unable to determine the exact relationship between resources. Hints are created to ‘electronically describe’ the ambiguity in those cases. Consider the Java example below:

class Customer
{

// send email to the customer
public void sendEmail(int emailType)
{

...
...

}

}
class Sale
{

// This method processes a purchase by a customer
public void purchase(Customer cust, Item item)
{

// charge the customer
...
...
// send the customer a confirmation email
cust.sendEmail(CONFIRMATION);

}

}

}

In this example, the classes and methods will all be resources (software artifacts). The resource Sale will has an ambiguous relationship to another resource named sendEmail in object cust. Ambiguous relationship information is created about the call, possibly including the description “send the customer a confirmation email”.

Based the hint information SIE 18 would, in most instances, find the correct method (sendEmail in class Customer).

Application to Database Relationship Inference

Most enterprise level applications use databases to store application information. The application code accesses the database in many different ways. For instance, some applications use SQL queries whereas others use language/platform specific features to access databases. Moreover, SQL queries may be static or built dynamically.

MDGs 28 understand the language/platform specific database access features. They extract the database access information including schema, table, column, stored procedure etc using this understanding. Moreover, MDGs 28 grammatically parse the SQL statements—static and dynamic, and extract the database access information from these statements.

Once the database access information is obtained, ambiguous references are stored that suggests linkage between the resource (accessing the database) and the database access information for each instance. For example, an ambiguous reference may be created for a ‘Java method’ resource with information that the method does a select on table tb 1 and column col 1.

When attempting to identify semantic relationship dependencies, SIE 18 performs internally created semantic searches to identify the correct table and column within the database (which is discovered as another application within ARC 16 and converts the ambiguous reference to a concrete relationship).

Cross Application Relationship Inference

Enterprise applications are often composite applications in which subcomponents of the application make calls to other subcomponents. Each subcomponent may or may not be developed using the same development technology. For instance, one subcomponent may access resources in another subcomponent by direct API's, or via message queue.

For any case in which an atomic application invokes API's on other application, MDGs 28 create ambiguous references for each such instance. When trying to identify semantic relationship dependencies, SIE 18 infers, using semantic search, the exact API on the other application and converts the hints to concrete relationships between the applications.

If the applications communicate via messages, custom plug-in modules are added to the application MDGs 28. These plug-in modules understand the messages and the message sender and receiver formats within the applications. The message content plug-in modules create the ambiguous between the applications from the information contained in the messages. This ambiguous reference (message information) is later used by SIE 18 to search for and resolve the reference into a concrete relationship.

Multi-Hop Relationship Inference

In a composite enterprise application, there may be numerous relations across atomic applications. SIE 18 has the ability to navigate these relations, jumping multiple applications in the process.

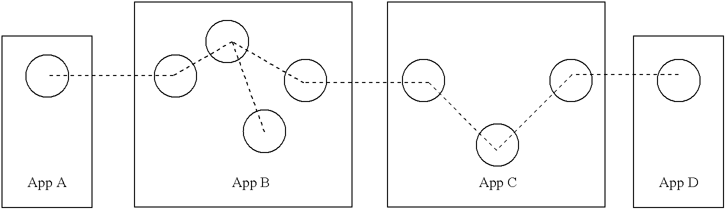

In the example above, SIE 18 could start at application A, and follow the resource relationships to application D via application B and application C. SIE 18 may use a heuristic, recursive semantic search based approach to determine when to hop across an application and when to stop at the edge of an application.

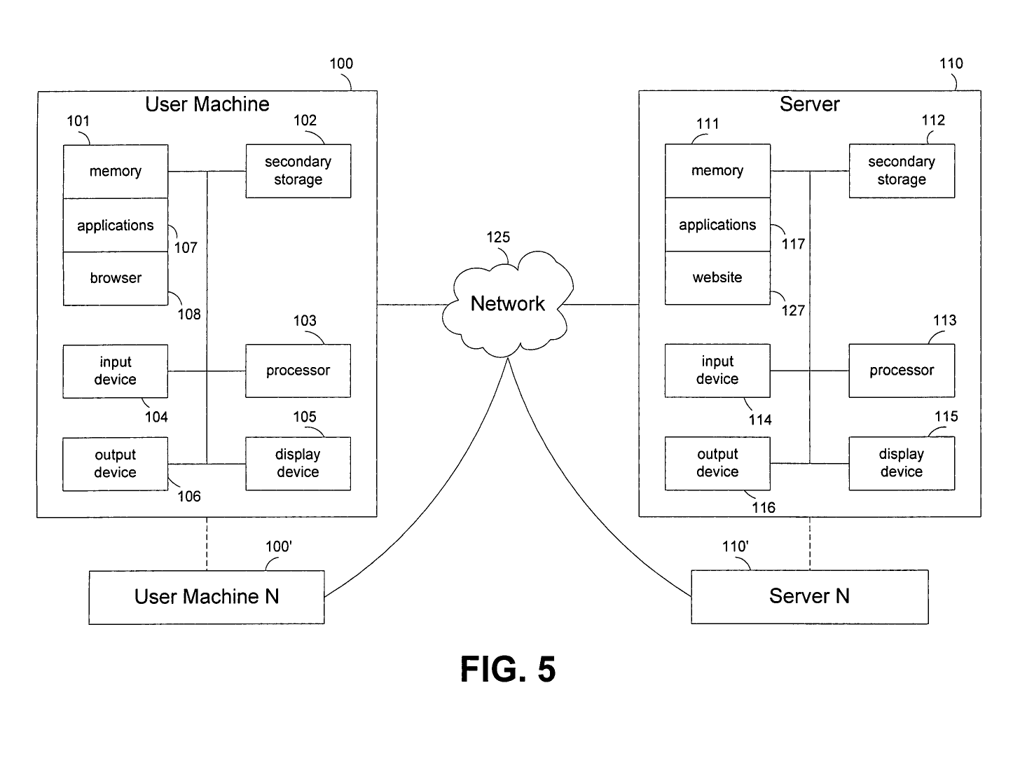

With reference now to FIG. 5, shown is a hardware diagram illustrating exemplary hardware that may be used to implement system 10 for integrating and adopting a service-oriented architecture. Shown are user machine 100 connected to server 110 via network 125 (e.g., Internet, LAN or other network). IQ Server 12 may be stored on and executed by server 110 while user may use user machine 100 to run and interact with IQ Server 12 (e.g., instructing IQ Server 12 to discover applications and/or running IQ Search 24 to search discovered application services). Other user machines, such as user machine 100′ may also be connected with network 125 for other users, while other servers, such as server 110′ may also support or implement system 10. Other servers may include application services to be discovered by IQ Server 12. User machines 100′ and servers 110′, may include the same or similar components as user machine 100 and server 110. Only two user machines and two servers are shown for illustrative purposes only; many user machine and server configurations are possible, with less or more user machines and servers.

User machine 100 illustrates typical components of a user machine. User machine 100 typically includes a memory 101, a secondary storage device 102, a processor 103, an input device 104, a display device 105, and an output device 106. Memory 101 may include random access memory (RAM) or similar types of memory, and it may store one or more applications 107, and a web browser 108, for execution by processor 103. Secondary storage device 102 may include a hard disk drive, floppy disk drive, CD-ROM drive, or other types of non-volatile data storage. Processor 103 may execute applications 107 stored in memory 101 or secondary storage 102, or received from the Internet or other network 125, and the processing may be implemented in software, such as software modules, for execution by computers or other machines. Such applications 107 may include instructions executable to interact with IQ Server 12 and IQ Search 24 and to run methods described above. The applications preferably provide graphical user interfaces (GUIs) through which user may interact with IQ Server 12 and IQ Search 24. Input device 104 may include any device for entering information into user machine 100, such as a keyboard, mouse, cursor-control device, touch-screen, microphone, digital camera, video recorder or camcorder. The input device 104 may be used to enter information into GUIs during interaction with IQ Server 12. Display device 105 may include any type of device for presenting visual information such as, for example, a computer monitor or flat-screen display. The display device 105 may display the GUIs described above. Output device 106 may include any type of device for presenting a hard copy of information, such as a printer, and other types of output devices include speakers or any device for providing information in audio form.

Web browser 108 may be used to access the IQ Server 12 through a web site 127 or otherwise and may display various web pages and GUIs through which the user can interact with IQ Server 12 and IQ Search 24. Examples of web browsers include the Netscape Navigator program and the Microsoft Internet Explorer program. Any web browser, co-browser, or other application capable of retrieving content from a network and displaying pages or screens may be used.

Examples of user machines 100 include personal computers, laptop computers, notebook computers, palm top computers, network computers, or any processor-controlled device capable of executing a web browser or other type of application for interacting with the system.

Server 110 typically includes a memory 111, a secondary storage device 112, a processor 113, an input device 114, a display device 115, and an output device 116. Memory 111 may include RAM or similar types of memory, and it may store one or more applications 117 for execution by processor 113. Such applications may include IQ Server 12, IQ Search 24 and MDGs 28. Secondary storage device 112 may include a hard disk drive, floppy disk drive, CD-ROM drive, or other types of non-volatile data storage. Processor 113 may execute the application(s) 117, including IQ Server 12 and IQ Search 24, which are stored in memory 111 or secondary storage 112, or received from the Internet or other network 125. Input device 114 may include any device for entering information into server 110, such as a keyboard, mouse, cursor-control device, touch-screen, microphone, digital camera, video recorder or camcorder. Display device 115 may include any type of device for presenting visual information such as, for example, a computer monitor or flat-screen display. Output device 116 may include any type of device for presenting a hard copy of information, such as a printer, and other types of output devices include speakers or any device for providing information in audio form.

Server 110 may store a database structure in secondary storage 112, for example, for storing and maintaining information regarding discovered application services, e.g., ARC 14. For example, server 110 may maintain ARC 14 as a relational or object-oriented database including application services ontology and dynamically generated ODs. Using the database structure, IQ Server 12 and IQ Search can perform operations and methods described herein.

Also, processor 113 may execute one or more software applications 117, including IQ Server 12 and IQ Search 24 in order to provide the functions described in this specification, specifically in the methods described above, and the processing may be implemented in software, such as software modules, for execution by computers or other machines. The processing may provide and support web pages and other GUIs described in this specification and otherwise for display on display devices associated with the user machines 100. The term “screen” refers to any visual element or combinations of visual elements for displaying information or forms; examples include, but are not limited to, GUIs on a display device or information displayed in web pages or in windows on a display device. The GUIs may be formatted, for example, as web pages in HyperText Markup Language (HTML), Extensible Markup Language (XML) or in any other suitable form for presentation on a display device depending upon applications used by users to interact with system 10.

The GUIs preferably include various sections, to provide information or to receive information or commands. The term “section” with respect to GUIs refers to a particular portion of a GUI, possibly including the entire GUI. Sections are selected, for example, to enter information or commands or to retrieve information or access other GUIs. The selection may occur, for example, by using a cursor-control device to “click on” or “double click on” the section; alternatively, sections may be selected by entering a series of key strokes or in other ways such as through voice commands or use of a touch screen. or similar functions of displaying information and receiving information or commands.

Although only one server 110 is shown, system 10 may use multiple servers as necessary or desired to support the users and may also use back-up or redundant servers to prevent network downtime in the event of a failure of a particular server. In addition, although user machine 100 and server 110 are depicted with various components, one skilled in the art will appreciate that these machines and the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling a computer system, such as user machine 100 and server 110, to perform a particular method, such as methods described herein.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. A system for integrating and adopting a service-oriented architecture that utilizes such semantic searching, comprising:
an application discovery and semantic analysis software tool, including:
a discovery engine that discovers application services;
an application resource catalog that stores the discovered application services as software constructs in an application services ontology; and
a semantic inference engine that semantically analyzes the software constructs in the application services ontology to determine relationships between the application services and enable more efficient searching of the discovered application services.

2. The system of claim 1 further comprising an application services search software tool that enables a user to search the discovered application services.

3. The system of claim 2 wherein the application services search software tool utilizes a semantic algorithm to search the discovered application services.

4. The system of claim 2 wherein the application services search software tool utilizes the semantic inference engine to semantically search the discovered application services.

5. The system of claim 1 further comprising discovery meta-data generators that reads application content and converts the application content into a common syntax for storage in the application resource catalog.

6. The system of claim 5 wherein the application discovery and semantic analysis software tool comprise the discovery meta-data generators.

7. The system of claim 5 wherein the discovery meta-data generators gather application content regarding the application services.

8. The system of claim 7 wherein the gathered application content is stored in the application resource catalog.

9. The system of claim 8 wherein the gathered application content is stored as a resource description format (RDF) graph in the application resource catalog.

10. The system of claim 7 wherein the application content includes structured application content and unstructured application content.

11. The system of claim 1 wherein the application resource catalog further comprises dynamically-formed ontology documents that include software constructs and other associated application content.

12. A computerized method for integrating and adopting a service-oriented architecture that utilizes such semantic searching, comprising:
gathering application content;
identifying application services from gathered application content;
populating an application resources catalog with application services identified from application content, wherein the application resources catalog is populated with an ontology created from identified application services and information from gathered application content; and
semantically identifying dependencies and semantic relationships between application services from ontology.

13. The computerized method of claim 12 further comprising dynamically generating ontology documents comprising software constructs, that are the identified application services, and other application content related to the software constructs.

14. The computerized method of claim 13 wherein the semantically identifying semantically scans and analyzes the dynamically generated ontology documents.

15. The computerized method of claim 14 further comprising optimizing the semantically analyzed information.

16. The computerized method of claim 12 further comprising semantically searching identified dependencies and semantic relationships to located related an application services.

17. The computerized method of claim 12 wherein the application resources catalog is a database.

18. The computerized method of claim 12 wherein the identifying application services applies a deterministic algorithm to the gathered application content to identify application services.

19. The computerized method of claim 12 wherein the populating comprises generating the ontology.

20. The computerized method of claim 12 wherein the gathering application content comprises reading meta-data from enterprise software.

21. The computerized method of claim 12 wherein the gathering application content comprises discovering application documentation.

22. The computerized method of claim 12 further comprising indexing application data.

23. A computer readable medium comprising instructions for performing the method recited in claim 12.

24. A computerized method for discovering application services, comprising:
generating an application services ontology, wherein the application services ontology includes application resources;
building references between application resources, wherein the references indicate related application resources;
dynamically generating ontology documents, wherein the ontology documents comprise application resources and related content; and
semantically scanning and analyzing the ontology documents, wherein semantic relationships between application resources are identified.

25. The computerized method of claim 24 further comprising optimizing the semantically analyzed information.

26. The computerized method of claim 24 wherein generating an application services ontology comprises;
gathering application content; and
analyzing the gathered application content with a deterministic algorithm to identify application resources.

27. The computerized method of claim 24 wherein the application resources include software constructs stored in the ontology as ontology anchors.

28. A computer readable medium comprising instructions for performing the method recited in claim 24.

29. A computerized method for discovering application services, comprising:
reading application content, wherein the application content includes application services and other application data;
discovering application documentation in the application content;
indexing application data from the application content; and
resolving application relations, wherein the application relations indicate relationships between application services and are resolved using one or more semantic algorithms.

30. The computerized method of claim 29 further comprising pre-processing reports based on the resolved application relations.

31. The computerized method of claim 29 wherein discovering application documentation comprises applying deterministic algorithms to the application content.

32. The computerized method of claim 29 further comprising storing application data in an ontology, wherein the ontology comprises ontology anchors.

33. The computerized method of claim 32 wherein the ontology anchors are application constructs.

34. The computerized method of claim 33 further comprising dynamically generating ontology documents, wherein the ontology documents are attached to the ontology anchors.

35. A computer readable medium comprising instructions for performing the method recited in claim 29.
